(19) United States
(12) Patent Application Publication
(10) Pub. No.: US 2013/0182430 A1
(43) Pub. Date: Jul. 18, 2013

(54) Planar LED Lighting Apparatus

(71) Applicant: Bor-Jen WU, New Taipei City (TW)

(72) Inventor: Bor-Jen WU, New Taipei City (TW)

(73) Assignee: NAN YA PHOTONICS INC., New Taipei City (TW)

(21) Appl. No.: 13/462,925

(22) Filed: May 3, 2012

(30) Foreign Application Priority Data
Jan. 17, 2012 (TW) 101101726

(51) Int. Cl. F21V 13/02; F21V 7/04; F21V 7/00

(52) U.S. Cl. 362/235

(57) ABSTRACT

A planar LED lighting apparatus includes a housing and multiple LEDs. The housing includes a reflective body and a light output surface opposing the reflective body. The multiple LEDs are mounted on sidewalls of the housing, and light from the multiple LEDs is reflected by the reflective body to travel toward the light output surface.

### BACKGROUND OF THE INVENTION

1. Field of the Invention

The present invention relates to a planar lighting apparatus, especially to a planar LED lighting apparatus.

2. Description of the Related Art

Lighting is important to our daily life, and after Edison invented the light bulb, we need lighting day and night. Current lighting assemblies mainly include incandescent light bulbs, fluorescent tubes, and compact fluorescent lamps. Compact fluorescent lamps are used to replace incandescent light bulbs to provide compatible luminance in same operation manner. Fluorescent tubes are popularly used in offices or public places of large area.

As illustrated in FIG. 1, a housing 10 has four fluorescent tubes 20 inside. The fluorescent tube 20 emits light uniformly in all directions. To increase light traveling to a light output face at the bottom side of the housing 10, three reflective bodies 12 are installed in the housing 10 with each of them placed between two adjacent ones of the four fluorescent tubes 20. The light output face is equipped with an anti-dazzle grille 16 or a lampshade.

For the present, environmental protection issues of power saving, low carbon consumption, and products without mercury are highly concerned, and LEDs (light emitting diodes) happen to meet the mentioned requirements. Besides, as LEDs are solid state devices, unlike traditional fluorescent tubes made of fragile glass, therefore they are far more convenient for transportation than traditional fluorescent tubes. In addition, LEDs have the advantages of small size and directional lighting, so they are suitable to be applied in lighting applications requiring small size or directional lighting, and are therefore becoming the main choice of next generation lighting in replacing traditional fluorescent tubes.

Please refer to FIG. 2, which illustrates a cross sectional view of a prior art planar lighting apparatus using LEDs. The apparatus has a housing 10, which includes a plurality of LEDs 22, and an anti-dazzle grille 16 or a lampshade on a light output face.

Although the small size of LEDs have the advantage of being capable of reducing the thickness of a lighting apparatus, however, the small size can also make the light intensity in a unit area so high as to result in a dazzling effect. To reduce the dazzling effect, one solution is to utilize a frosted lampshade to diffuse the light rays emitted from each LED. However, the intensity of output light will be attenuated accordingly. Besides, the light emitting efficiency of LEDs has been increasing per year as the manufacturing process keeps improving, and the increased light intensity has added challenges to the diffusion effect of the frosted lampshade. Under this circumstance, the frosted lampshade has to increase scattering effect to make the output light uniform, but this will further sacrifice the intensity of the output light.

In view of the mentioned problems, the present invention proposes a planar LED lighting apparatus, which is not only capable of reducing the thickness of the lighting apparatus, but capable of using a less frosted lampshade, or even using no lampshade, to provide a uniform planar lighting.

### SUMMARY OF THE INVENTION

To attain the goals mentioned above, the present invention proposes a planar LED lighting apparatus, which includes a housing and multiple LEDs.

The housing has a light output face, a reflective body, a first side wall, and a second side wall, wherein the reflective body is opposing the light output face, the first side wall and the second side wall are opposing each other and located between the light output face and the reflective body.

The multiple LEDs are located on the first side wall and the second side wall, and light from the multiple LEDs is reflected by the reflective body to travel toward the light output face.

In one embodiment, the reflective body has a first inclined surface for reflecting LED light from the first side wall, and a second inclined surface for reflecting LED light from the second side wall.

In another embodiment, the reflective body has a first curved surface for reflecting LED light from the first side wall, and a second curved surface for reflecting LED light from the second side wall.

The reflective body has a sufficient height for preventing LED light from traveling between the first side wall and the second side wall.

Preferably, the mentioned planar LED lighting apparatus further includes a lampshade on the light output surface, and the lampshade can be a transparent lampshade, a frosted lampshade, or a lampshade having a specific optical structure.

In still another embodiment, the housing further has a third side wall and a fourth side wall, opposing each other and located between the light output face and a second reflective body.

The mentioned planar LED lighting apparatus further has a third set of LEDs installed on the third side wall and a fourth set of LEDs installed on the fourth side wall.

In one embodiment, the shape of the reflective body is a reversed pyramid.

In another embodiment, the shape of the reflective body is a reversed pyramid having four curved surfaces for reflecting light.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1 illustrates a cross sectional view of a prior art planar lighting apparatus using fluorescent tubes.

FIG. 2 illustrates a cross sectional view of a prior art planar lighting apparatus using LEDs.

FIG. 3 illustrates a cross sectional view of a planar lighting apparatus using LEDs according to a preferred embodiment of the present invention.

FIG. 4 illustrates a cross sectional view of a planar lighting apparatus using LEDs according to another preferred embodiment of the present invention, wherein each of the side walls of a housing has an inclined surface.

FIG. 5 illustrates a cross sectional view of a planar lighting apparatus using LEDs according to another preferred embodiment of the present invention, wherein a reflective body has a curved surface.

FIG. 6 illustrates a cross sectional view of a planar lighting apparatus using LEDs according to another preferred embodiment of the present invention, wherein a reflective body has two different slopes on both sides.

FIG. 7 illustrates a cross sectional view of a planar lighting apparatus using LEDs according to still another preferred embodiment of the present invention, wherein the planar lighting apparatus has two reflective bodies.

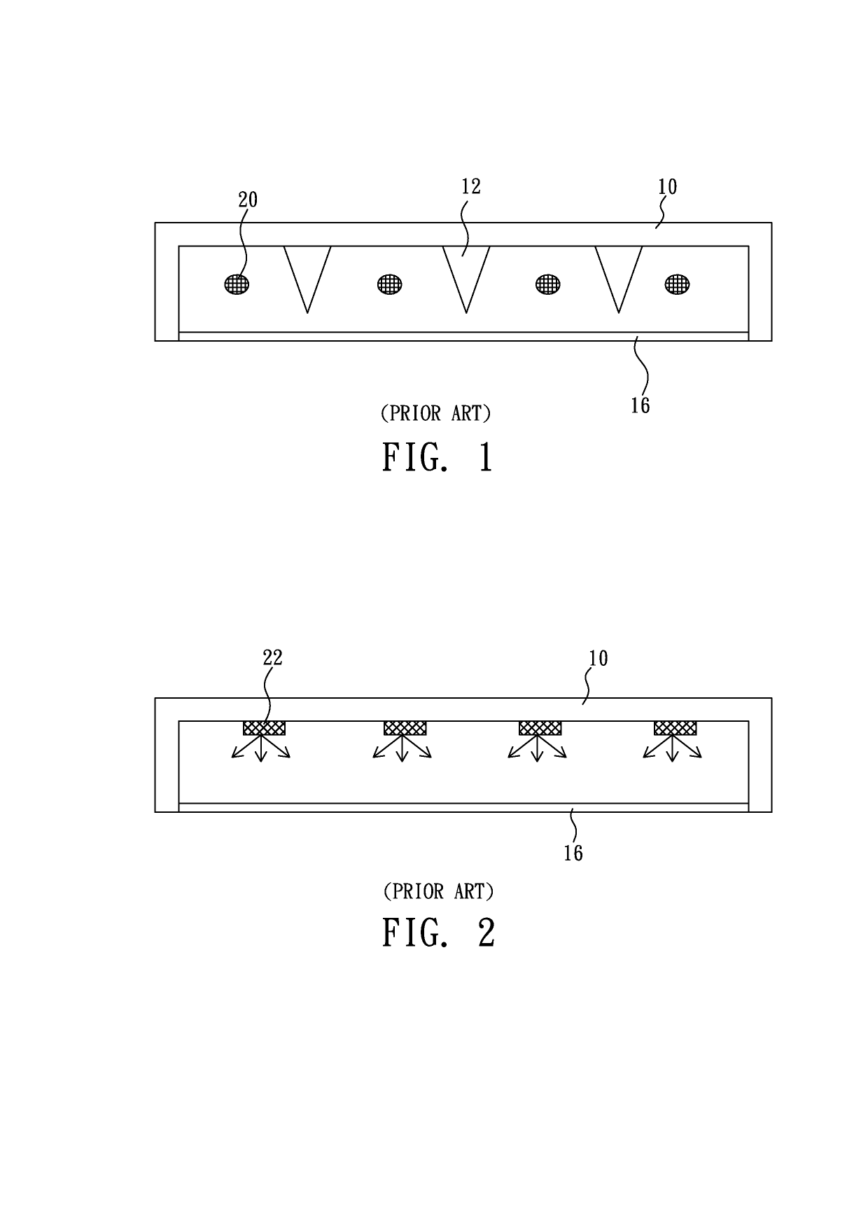

### DETAILED DESCRIPTION OF THE PREFERRED EMBODIMENTS

The present invention mainly puts LEDs on the sides or side walls of a housing, and designs a reflective body for reflecting the axial light from the LEDs to a light output face, and thereby provides a planar light source. The reflective body can also prevent LED light from traveling between two opposite sides of the housing.

The reflective body basically is an extruding object, having a sufficient height for preventing LED light from traveling between two opposite sides, and providing an excellent reflection effect. The reflecting surface of the reflective body can be a plain surface, a multi-slope surface, or a curved surface, to reflect light from the LEDs to the light output surface. The present invention will be described in more detail hereinafter with reference to the accompanying drawings that show the preferred embodiments of the invention.

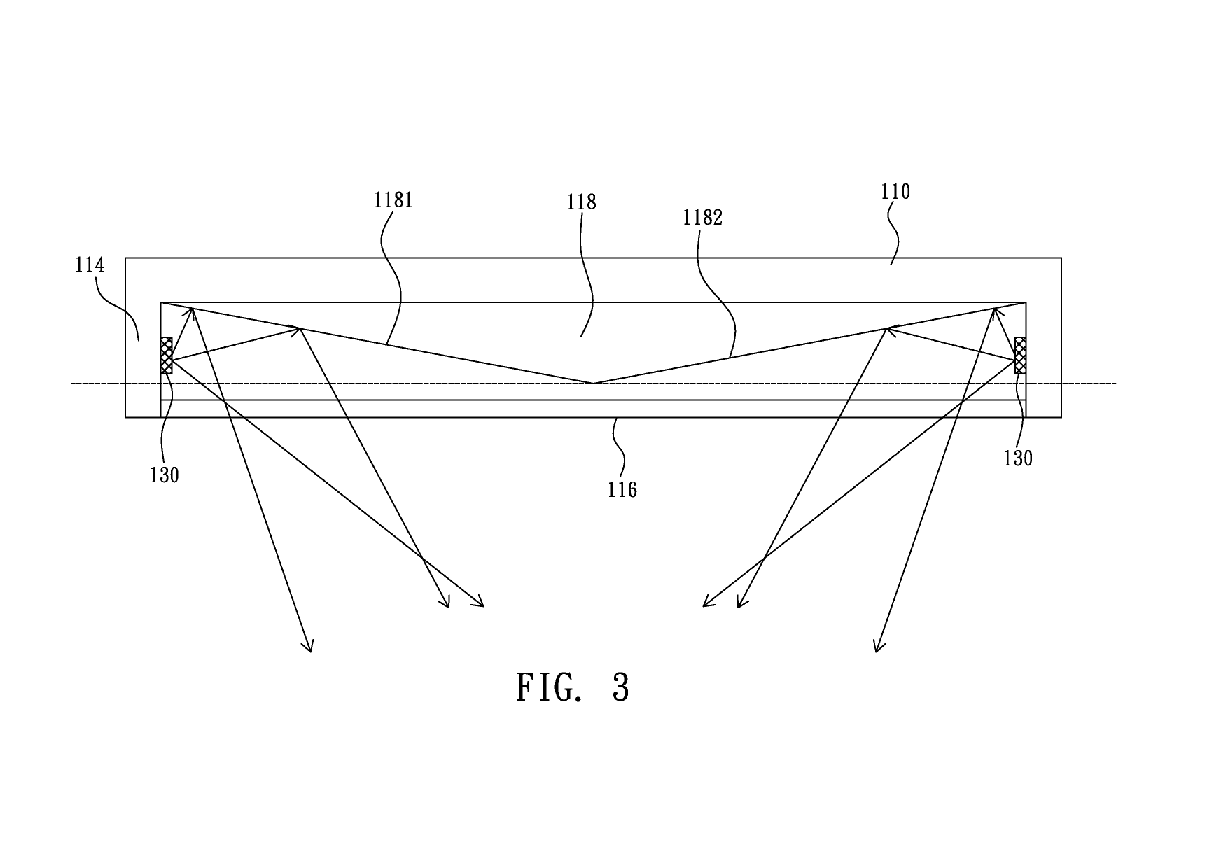

Please refer to FIG. 3. A housing 110 has a side wall 114 and a reflective body 118, and a lampshade 116 can be installed on a light output face of the housing 110. Multiple LEDs 130 are mounted on the side wall 114, and light from the LEDs 130 is reflected by the reflective body 118 and traveling to the light output face.

The material of the housing 110 can be a metal to provide a supporting structure for the whole planar lighting source.

The reflective body 118, fixed on an inner surface of the housing 110, is an extruding structure. In FIG. 3, the reflective body 118 has a first reflecting surface 1181 and a second reflecting surface 1182 for reflecting light from the LEDs 130, wherein the first reflecting surface 1181 and the second reflecting surface 1182 are both of a plain shape, capable of providing a metallic reflecting surface or a scattering surface. The peak of the reflective body 118 is lower than the LEDs 130, so that light of the LEDs 130 one side (left side, for example) can be prevented from reaching the other side (right side, for example). As can be seen in FIG. 3, a dash line is used to indicate the lowest level of the reflective body 118, and all the LEDs 130 are located higher than the dash line. This arrangement can offer a superior lighting effect. The LEDs 130 can be of a multi-line structure, with the lowest line of the multi-line structure higher than the dash line.

The lampshade 116 can be a transparent lampshade, a frosted lampshade, a lampshade with a striped pattern or a decorative pattern, or a lampshade with a specific optical structure. In one embodiment, the first reflecting surface 1181 and the second reflecting surface 1182 are metallic reflecting surfaces, and the lampshade 116 can be a frosted lampshade or a lampshade having a specific diffusion structure to diffuse LED light and produce a uniform light source. In another embodiment, the first reflecting surface 1181 and the second reflecting surface 1182 are scattering surfaces, and the lampshade 116 is preferably transparent.

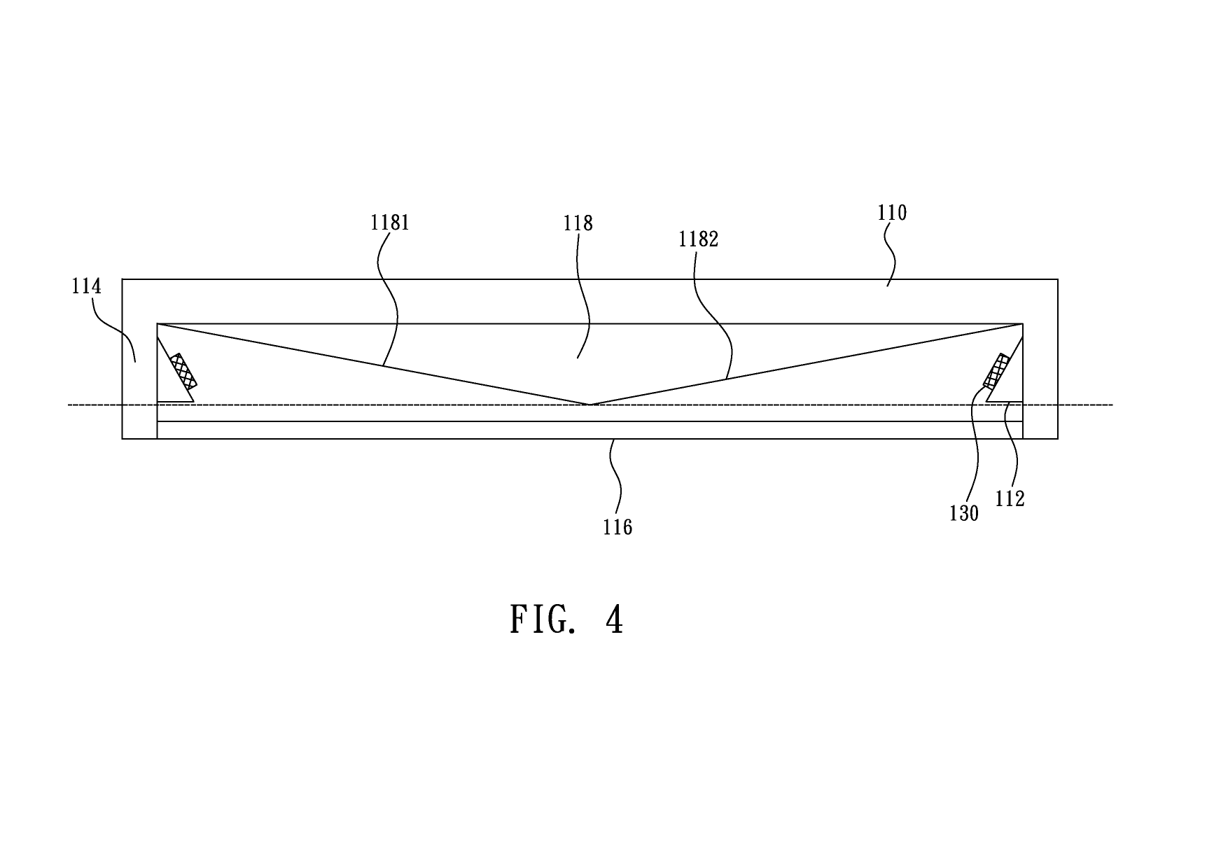

General LEDs have a light emitting angle or a light pattern determined by their packaging structures, and the light pattern has a central axis. To be applied to the present invention, the packaging structure of LEDs can be designed to provide a special light emitting angle. However, a more practical design, as illustrated in FIG. 4, is to install a supporter having an inclined surface 112 on the side wall 114 of the housing 110, and mount the LEDs 130 on the inclined surface 112. By this, LEDs of general packaging structures can be used in the present invention—no special request is made on the LEDs, making the supply of the LEDs much easier. The supporter can be constructed by a printed circuit board, an aluminum substrate, a ceramic substrate, or by bending the side wall 114 inward.

In the present invention, the LEDs can be cool white light LEDs, or warm white light LEDs, or LEDs of a specific light wavelength, or a combination of LEDs of different light wavelengths.

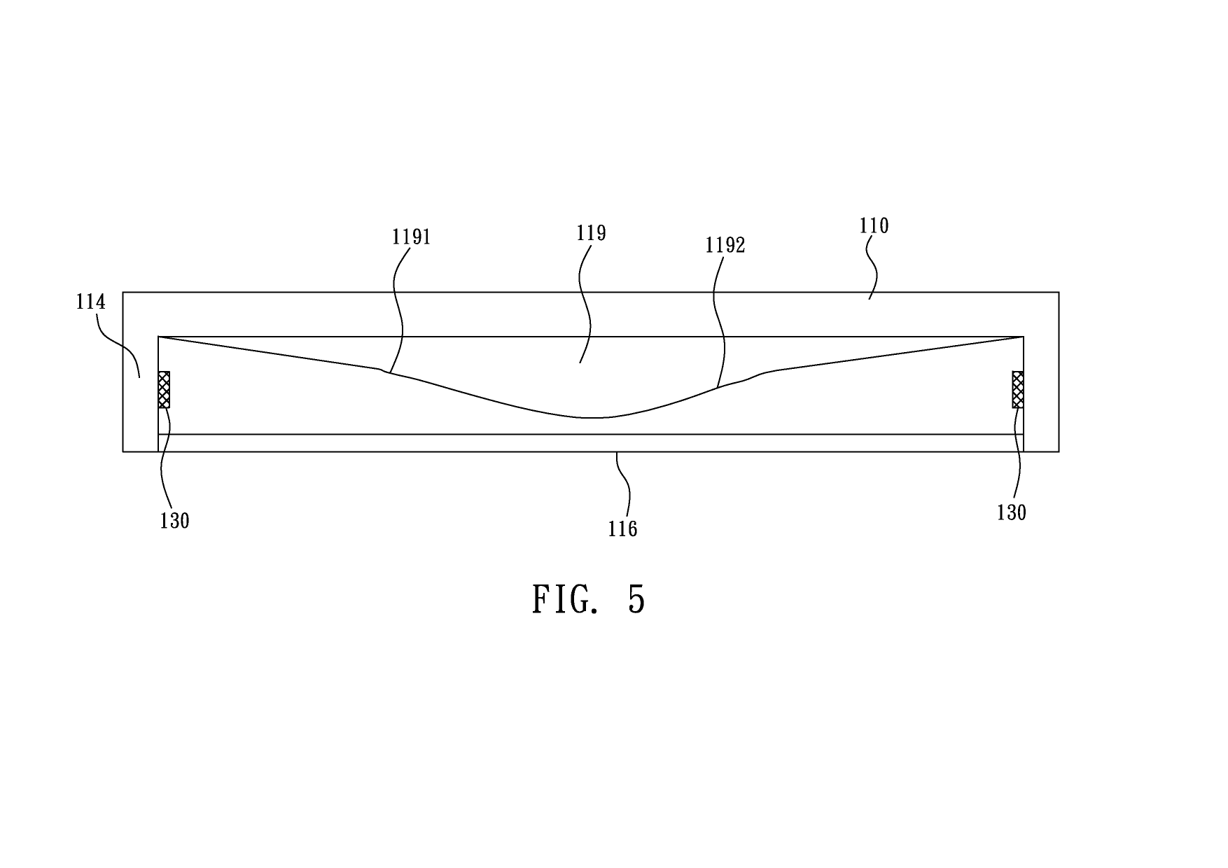

In another embodiment, the reflecting surface of the reflective body is a curved surface (instead of a plain surface). Please refer to FIG. 5, a reflective body 119 has a curved surface 1191 and a curved surface 1192. Although, as illustrated in FIG. 5, both the curved surface 1191 and the curved surface 1192 are of concave shape, they can also be of convex shape.

In the embodiments of FIG. 3 and FIG. 5, two sets of LEDs are located on two opposite side walls. However, as the housing 110 is in fact of a rectangular shape having four side walls, all the four side walls can be used to mount LEDs to increase light intensity. When all the four side walls are mounted with LEDs, the structure of the reflective body can be of the shape of a reversed pyramid, and each face of the reversed pyramid can be a plain surface or a curved surface.

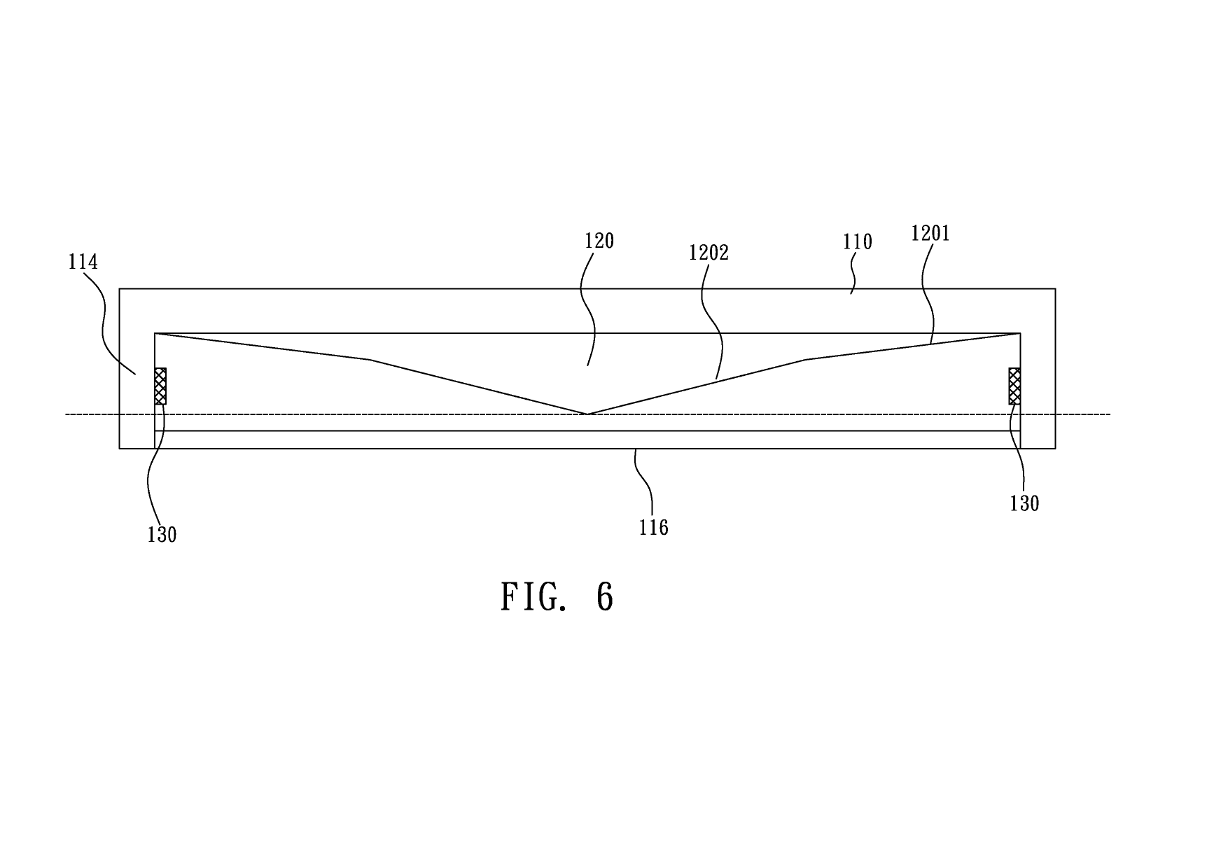

In another embodiment, the reflecting surface of the reflective body can have different slopes. As illustrated in FIG. 6, a reflective body 120 has two inclined surfaces 1201 and 1202 of two different slopes. In this embodiment, the inclined surface 1201, nearer to the LEDs 130 than the inclined surface 1202, has a smaller slope than that of the inclined surface 1202. However, it can also be designed in another way that the inclined surface 1201, nearer to the LEDs 130 than the inclined surface 1202, has a larger slope than that of the inclined surface 1202. By using different slopes combinations, the lighting apparatus of the present invention can have different light patterns to meet different market requirements.

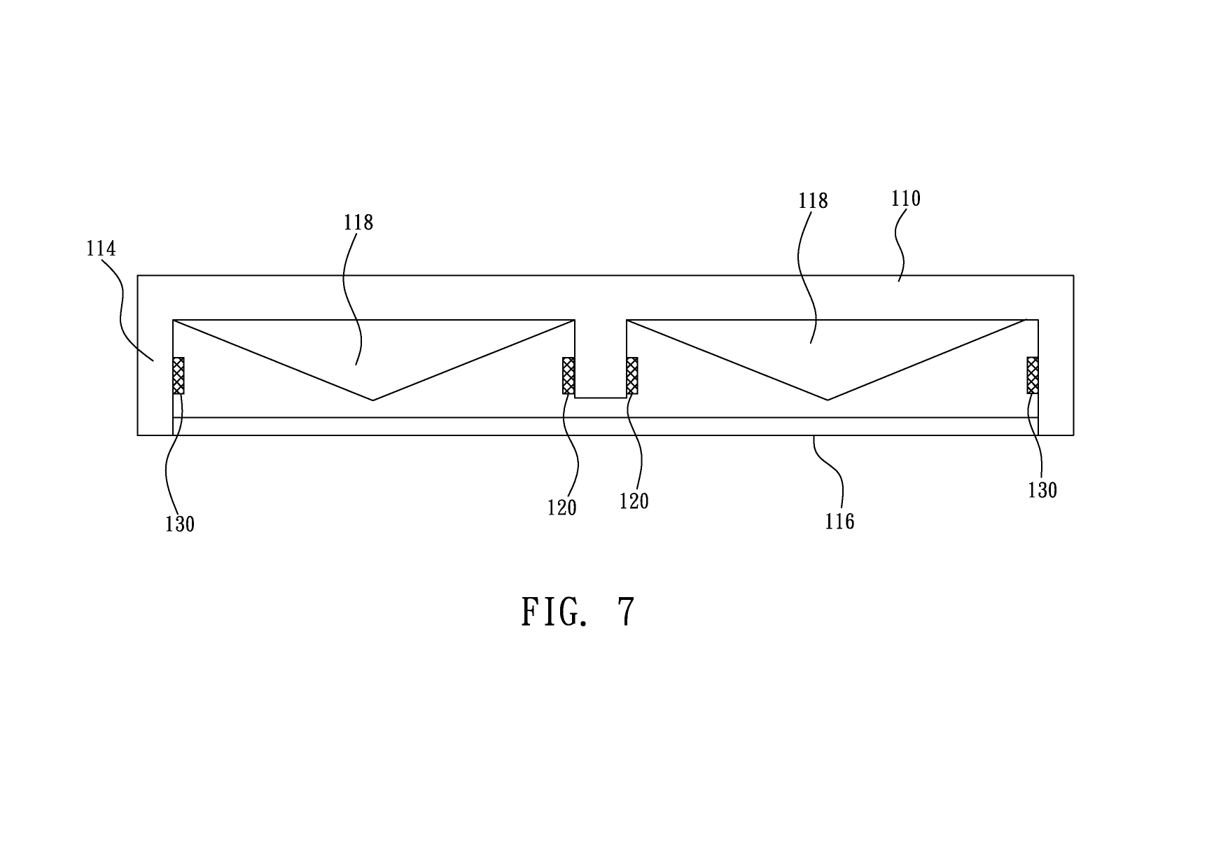

In still another embodiment, more than one reflective body is used. Please refer to FIG. 7, which illustrates two reflective bodies 118, and each of them is located between two sets of LEDs 130. This kind of multiple reflective bodies design can provide a brighter light source. Each of the multiple reflective bodies can be designed to have a single inclined surface, multiple inclined surfaces, or a curved surface, etc.

The present invention, using light reflection to provide a planar LED light source, can have more uniform light output than traditional designs do, and can be free of a frosted lampshade, which is for light diffusion, to reduce light attenuation. To reduce light attenuation caused by reflection, the present invention is preferably designed to have one time reflection.

While the invention has been described by way of example and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance than the conventional structure and further complies with the patent application requirements and is submitted to the Patent and Trademark Office for review and granting of the commensurate patent rights.

What is claimed is:

1. A planar LED lighting apparatus, comprising:
a housing, having a light output face, a reflective body, a first side wall, and a second side wall, wherein said reflective body is opposing said light output face, and said first side wall and said second side wall are opposing each other and located between said light output face and said reflective body; and
multiple LEDs, located on said first side wall and said second side wall, and light from said multiple LEDs being reflected by said reflective body and traveling to said light output face;
wherein said reflective body has a height sufficient for preventing LED light from traveling between said first side wall and said second side wall.

2. The planar LED lighting apparatus as claim 1, wherein said reflective body has a first inclined surface for reflecting LED light from said first side wall, and a second inclined surface for reflecting LED light from said second side wall.

3. The planar LED lighting apparatus as claim 1, wherein said reflective body has a first curved surface for reflecting LED light from said first side wall, and a second curved surface for reflecting LED light from said second side wall.

4. The planar LED lighting apparatus as claim 1, further comprising a lampshade on said light output face.

5. The planar LED lighting apparatus as disclosed in claim 4, wherein said lampshade is a transparent lampshade or a frosted lampshade.

6. The planar LED lighting apparatus as claim 2, wherein said first inclined surface has two reflecting surfaces of two different slopes.

7. The planar LED lighting apparatus as claim 6, wherein said second inclined surface has two reflecting surfaces of two different slopes.

8. The planar LED lighting apparatus as claim 1, wherein said housing further has a third side wall and a fourth side wall located between said light output face and said reflective body.

9. The planar LED lighting apparatus as claim 8, further comprising a third set of LEDs on said third side wall and a fourth set of LEDs on said fourth side wall.
